(19) United States
(12) Patent Application Publication
(10) Pub. No.: US 2021/0075599 A1
(43) Pub. Date: Mar. 11, 2021

(54) BLOCKCHAIN VOTING SYSTEM AND METHOD WITH AUDIT TRAIL VERIFICATION

(71) Applicants: Douglas J. Pepe, Atlantic Highlands, NJ (US); Michael A. Abboud, Oceanport, NJ (US)

(72) Inventors: Douglas J. Pepe, Atlantic Highlands, NJ (US); Michael A. Abboud, Oceanport, NJ (US)

(21) Appl. No.: 16/437,605

(22) Filed: Jun. 11, 2019

Related U.S. Application Data
(60) Provisional application No. 62/683,406, filed on Jun. 11, 2018.

(51) Int. Cl. H04L 9/08; G06K 19/06; H04L 9/30; G07C 13/00

(52) U.S. Cl. CPC H04L 9/088; G07C 13/00; H04L 9/30; G06K 19/06028

(57) ABSTRACT

A voting system comprises an apparatus and method to provide several advancements to existing voting technology. The voting system combines modern, cryptographically secure blockchain technology with a hard-copy, paper audit trail, and a means for immediate voter verification. The method has the added benefit of eliminating exit polling, if desired by governmental authorities, as real-time tabulations of all votes cast can be calculated using the publicly-available blockchain data.

### CROSS-REFERENCE TO RELATED APPLICATIONS

The present application claims the benefit of U.S. Provisional Application No. 62/683,406 filed Jun. 11, 2018, the disclosure of which is hereby incorporated by reference in its entirety.

### FIELD

The present disclosure relates to the field of voting technology; in particular, a system and methods for casting, cryptographically securing, and verification of votes using blockchain technology combined with a paper audit trail and independent voter verifiability.

### BACKGROUND

Voting is the right and duty of the people in a democracy. But there can be no democracy without election integrity. Ensuring the rectitude of election results goes to the heart of all democratic political systems.

Factors that a voting system must contend with include trust, integrity, verifiability, voter anonymity, and security. Voting systems in current use deploy various technologies in an attempt to produce trustworthy and convincing evidence that an election yielded the correct outcome.

Each of these systems has its flaws. Classic paper-based voting systems seek to accomplish this objective with printed ballots, which are cast by voters and counted by electronic scanning and other technologies. These dated systems are cumbersome, often yield false or improperly tallied votes, and rely for their ultimately integrity on a system of haphazard and unwieldy recounts. See, e.g., Bush v. Gore, 531 U.S. 98 (2000). More modern electronic voting systems, however, suffer from a risk of infiltration and hacking, requiring some “software independent” means to assure voting integrity. Both systems lack an efficient, secure and effective mechanism for voters to effectively verify that their votes have been properly cast, recorded and tallied in the election.

The legitimacy of an election outcome should be convincing to everyone. The possibility of error, fraud or tampering requires assurances of voting accuracy, whether conducted by counting paper ballots or using computer technology. This involves three key elements that any properly constructed election system should satisfy. First, the transmission and tallying of votes must be secure. Second, all votes in the system should be fully auditable through an independent and redundant audit trail. Third, all votes should be verifiable by the voters themselves.

System Integrity. The integrity of the election depends on maintaining a secured chain-of-custody of the voting machines and the ballots. Evidence-based elections require that election workers follow security procedures and document that election machines and paper records are properly secured from start to finish. Experts agree that the most secure current voting system is one where a voter marks a paper ballot, and the ballots are then counted by an optical scanner machine. Though optical scanner machines are not wholly immune from cyberattacks, a paper ballot filled out by a voter produces an auditable paper trail that can easily detect attacks. In recent years, many jurisdictions in the United States have eplaced paperless computerized voting machines with systems that scan or produce a VVPAT that can be viewed by the voter. The “software independent” record provides important security redundancy, act as a safeguard against cyberattacks, and provide voters with more confidence that their votes have been counted accurately. A public post-election audit of the voting machines can be used to confirm the accuracy of the electronic record reported by the machine.

Audit Trail. An audit trail typically consists of paper ballots that represent a “software independent,” tangible, physical record of the vote. Paper ballots are durable, tamper-evident, voter-verifiable records that can be used in statistical post-election audits to provide assurance that a reported outcome is correct. An outcome is incorrect if it differs from the set of winners output determined by a perfectly accurate manual tabulation of the audit trail.

Post-election audits provide assurance that a reported outcome is correct by examining some or the totality of an audit trail. There are two kinds of routine post-election audits: compliance and risk-limiting. A compliance audit generates qualitative evidence while risk-limiting audit generates quantitative evidence. A compliance audit checks that the audit trail is sufficiently complete and accurate to identify the winner. The purpose of a compliance audit is to generate convincing affirmative evidence that a full hand count of the audit trail would reflect the correct outcome of the election. A compliance may include poll book accounting, ballot accounting, check of chain-of-custody, check of security, and event log inspection. A risk-limiting audit checks the audit trail statistically to determine whether the vote-tabulation system found the correct winners and, with high probability, corrects the outcome if the system was wrong. A risk-limiting audit confirm election results at a high probability by drawing a random sample of ballots from the pool of cast votes. In the case of a decisive contest, election workers can audit a small sample of ballots, while a close race will require auditing a comparatively large sample to confirm the winner. Risk-limiting audits require systems to provide a secure link between paper ballots and electronic ballot data, so that officials can compare a physical paper trail with the electronic count, all while protecting voter anonymity.

Voter Verification. Physical records of votes are commonly referred to as a voter-verifiable paper record (VVPR) or voter-verifiable paper audit trail (VVPAT) and are essential in an evidence-based election, where the voting system must be “software-independent.” VVPAT can take many forms: a hand-filled paper ballot; paper ballot filled out by the voter and tabulated by an optical scanning machine; or a printed receipt of votes cast on a Direct-Recording Electronic (DRE) voting machine that the voter uses to confirm that his or her vote was cast correctly. For a system to be “software-independent,” an undetected change or error in the system's software cannot lead to an undetected change or error in election results. A common way to meet this requirement is to have voters mark a paper ballot or have machines produce VVPRs.

A voting system assurance can also achieve software independence through an end-to-end verification (E2E-V) protocol. E2E-V provides a way to detect errors or fraud in the process of voting and counting process. E2E-V enable voters to monitor the integrity of the election. E2E-V also allows for eligibility verification where each voter can detect any change or deleted cast votes to prevent ballot-box stuffing. In an E2E-V approach, voters are provided with vote collection accountability, through evidence, receipt for casting a vote, or any failure of vote collection, and a dispute resolution mechanism. Each voter is provided with a protected receipt that is an encrypted or encoded version of their vote at the time the vote is cast. An encrypted receipt enables the protection of voter confidentiality and privacy. The voter can later use the receipt to check whether the vote is included correctly in a universally verifiable tabulation process, usually through a public bulletin board or ledger, where the set of encrypted ballots is published in an append-only manner. E2E-V requires many participants, and if there is an insufficient number of voters participating in verification, E2E-V can be combined with risk-limiting audits for an added layer of error or fraud protection.

Blockchain technology is a distributed database solution that maintains a continuously growing list of data records called blocks that are linked and secured using cryptography. Data is recorded in a blockchain ledger, which includes a list every transaction ever completed. Ledger entries are verified by one or more decentralized and redundant nodes on a network of nodes that can be public and permissionless or private and permissioned. The information about every transaction ever completed in a blockchain is shared and available to all nodes, making the system fully transparent to all participants with access to a node. The attributes of blockchain technology make it suitable for election purposes, where voters can post their votes onto a blockchain and the votes as well as the outcome are observable and verifiable in real-time by voters, election officials, news media and other participants.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

Applicant has perceived a need for an apparatus and methods that overcomes the drawbacks associated with aforementioned challenges of existing voting technology. Overcoming these drawbacks, and other benefits, are attendant to a voting system, apparatus, and methods disclosed herein.

An object of the present disclosure is a cryptographically secure voting system comprising at least one voting node comprising a computerized terminal having at least one computer processor, microprocessor, controller, memory storage device, data storage device, user input-output interface device, a first printer, a second receipt printer, a quick response code or barcode scanner (or other means to input a private key such as magnetic card reader or Universal Serial Bus I/O interface), and a network connection I/O interface device, the at least one voting node executing an instance of a voting blockchain protocol, the at least one voting node being operably engaged with a communications network to execute a permissioned or permission-less networking protocol; and, a vote key generator, the vote key generator comprising a cryptographically secure means to generate a cryptographic keypair offline and a third printer or output device, the vote key generator being operable to generate an output comprising a printed record, barcode or other image or file embedded with a public-private cryptographic keypair.

In an aspect of the present disclosure, a voting system consists of a voting apparatus and method comprising a network of computer terminals executing a secure, decentralized, permissioned or permission-less blockchain protocol, with a redundant, user-and-system verifiable paper audit trail. The voting apparatus comprises a Voting Node (“Voting Node”), Audit Roll (“Audit Roll”), and a Vote Key (“Vote Key”) generator, preferably a cryptographically secure offline keypair generator with a printer or other I/O mechanism. In an embodiment, the Voting Node is a computerized terminal having at least one computer processor, microprocessor, controller, memory storage device, data storage device, user I/O interface device, an internal printer (i.e., Audit Roll), a barcode (e.g., Quick Response Code) scanner, an external receipt printer, or a network connection I/O interface device. The computerized terminal may be configured with at least one or all components together to operate as a Voting Node. In another embodiment, one or more Voting Node executes a complete instance of the voting blockchain protocol (“Blockchain Protocol”). In a preferred embodiment, one or more Voting Node is connected to another Voting Node utilizing a secured, permissioned networking protocol. In yet another preferred embodiment, all the Voting Nodes are connected to all other Voting Nodes utilizing said networking protocol.

In another aspect of the present disclosure, a voting system consists of a method that enables a voter to access a blockchain record, generated by said voting Blockchain Protocol, to confirm at least one voting record. In an embodiment, a voter uses the said Vote Key generator to create a Vote Key (“Vote Key”) containing a cryptographic keypair. In a preferred embodiment, the Vote Key is generated as an output of said external printer at a polling location under the supervision of one or more poll workers. In another embodiment, the Vote Key generator produces a Vote Key output onto a paper receipt containing a public key and or private cryptographic keypair. In another embodiment, the paper receipt contains a printed barcode embedded with the public-private cryptographic keypair information. In another embodiment, Vote Key generator outputs a public-private cryptographic keypair on a magnetic stripe card or USB device. In another preferred embodiment, each private key is a one-time-use key in the Blockchain Protocol, corresponding to the signature of a single-vote only cast.

In another aspect of the present disclosure, the voting apparatus and method enables a voter to entera vote whereby the Voting Node requests voter to cryptographically sign a vote (“Vote Signature”) using the Vote Key. In an embodiment, upon a voter signing and casting a vote with a Vote Signature, said vote is distributed to one or more Voting Nodes, preferably all communicating Voting Nodes. In another embodiment, the distributed vote is secured cryptographically through the Blockchain Protocol. In yet another embodiment, upon a voter signing and casting a vote with a Vote Signature, the voter's public key is recorded on the Audit Roll of the apparatus, the record preferably along with numbers reflecting each cast by the voter according to a pre-published scheme. In yet another embodiment, the voter's public-private keypair are printed on a receipt, preferably a record of all casted votes is included on said receipt.

In another aspect of the present disclosure, the voting method enables a voter to access a blockchain record to confirm that a vote casted by said voter is recorded for verification. In an embodiment, the verification is provided in real-time at the Voting Node located at the polling location. In another embodiment, a voter can access the blockchain record using a blockchain explorer openly provided on the Internet. In yet another embodiment, a voter can challenge an incorrectly recorded vote using the said receipt and confirmed by an authorized reviewer. In a preferred embodiment, the recorded vote and receipt can be reconciled with the information generated contemporaneously by the Audit Roll of the voting apparatus.

Embodiments of the present disclosure provide for a cryptographically secure voting system comprising at least one voting node comprising a computerized terminal having at least one computer processor, microprocessor, controller, memory storage device, data storage device, user input-output interface device a first printer, quick response code scanner, and a network connection I/O interface device, the at least one voting node executing an instance of a voting blockchain protocol, the at least one voting node being operably engaged with a communications network to execute a permissioned networking protocol; and, a vote key generator operably engaged with the at least one voting node to access a blockchain record, the vote key generator comprising a cryptographically secure offline keypair and a second printer, the vote key generator being operable to generate a vote signature output comprising a printed barcode embedded with a public-private cryptographic keypair.

Further specific embodiments of the present disclosure provide for a method for cryptographically secure electronic voting, comprising creating, with a vote key generator operably engaged with at least one voting node to access a blockchain record, a cryptographic keypair; printing, with a printer communicably engaged with the vote key generator, a paper receipt comprising the cryptographic keypair; entering a voter input into a voting node, the voter input comprising a vote selection; entering a voter signature into the voting node, the voter signature comprising the cryptographic keypair; distributing the voter input to one or more voter nodes via a blockchain protocol to create a blockchain record associated with the voter input; recording, with an audit roll printer, the voter input on an audit roll; and, accessing, via a Web browser, a blockchain explorer to compare the audit roll with the blockchain record to verify accuracy of the voter input.

Further specific embodiments of the present disclosure provide for a method for cryptographically secure electronic voting, comprising creating, with a voting node executing a blockchain protocol, a voter signature comprising a cryptographic keypair; printing, with a printer, a machine-readable code corresponding to the voter signature; inputting a voter input and the voter signature into the voting node; creating, with the voting note, a blockchain record corresponding to the voter input and the voter signature; creating, with an audit log, an audit record corresponding to the voter input and the voter signature; printing, with an audit printer, the audit record; comparing, via a blockchain explorer application, the blockchain record and the audit record.

The foregoing has outlined rather broadly the more pertinent and important features of the present invention so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present invention. It should be realized by those skilled in the art that such equivalent structures do not depart from the spirit and scope of the invention as set forth in the appended claims.

### BRIEF DESCRIPTION OF DRAWINGS

The above and other objects, features and advantages of the present disclosure will be more apparent from the following detailed description taken in conjunction with the accompanying drawings, in which:

FIG. 1 is an exemplary illustration of a Voting Node according to an aspect of the present disclosure; and,

FIG. 2 is an exemplary illustration of the Voting System according to an aspect of the present disclosure.

### DETAILED DESCRIPTION

Exemplary embodiments are described herein to provide a detailed description of the present disclosure. Variations of these embodiments will be apparent to those of skill in the art. Moreover, certain terminology is used in the following description for convenience only and is not limiting. For example, the words “right,” “left,” “top,” “bottom,” “upper,” “lower,” “inner” and “outer” designate directions in the drawings to which reference is made. The word “a” is defined to mean “at least one.” The terminology includes the words above specifically mentioned, derivatives thereof, and words of similar import.

Unless otherwise defined, all terms (including technical and scientific terms) used herein have the same meaning as commonly understood by one of ordinary skill in the art to which these embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

It will be further understood that the terms “comprises,” “comprising,” “includes,” and/or “including,”, and variants thereof, when used herein, specify the presence of stated features, steps, operations, elements, and/or components, but do not preclude the presence or addition of one or more other features, steps, operations, elements, components, and/or groups thereof.

Numerous alternative embodiments of a voting system comprising a network of computer terminals executing a secure, decentralized, permission blockchain, with a redundant, user-and-system verifiable paper audit trail is described herein. In general, the voting system prises an apparatus and method to provide several advancements to existing voting technology. The voting system combines modern, cryptographically secure blockchain technology with a hard-copy, paper audit trail, and a means for immediate voter verification. The method has the added benefit of eliminating exit polling, if desired by governmental authorities, as real-time tabulations of all votes cast can be calculated using the publicly-available blockchain data.

Without being bound to theory, the Blockchain Protocol (herein after “Blockchain Protocol”) of the present disclosure preferably, but non-limiting, uses a public key infrastructure (“PKI”) mechanism. In PKI, a voter is provided with a pair of public and private keys (herein “keypair”) corresponding to a vote casting event. The public key is used in an address associated with the voter and the private key is for the authentication of the voter. A transaction (e.g., a casted vote) consists of the public key of the sender, public key of the receiver(s) (which can be a public key associated with a candidate or candidates), and the transferred vote(s). In about several minutes, the vote or signature can be written in a block. This new block is then linked to a previously written block. All blocks, including information about every transaction made, are stored in the disk storage of the users, called nodes. All the nodes store information about all recorded transactions of the distributed network and check the correctness of each new transaction made by using previous blocks. The nodes are “rewarded” for checking the correctness of transactions. This method is called mining, and it is confirmed with a Proof-of-Work. Proof-of-Work is an exemplary consensus mechanism. Other consensus protocols include Proof-of-Stake and permissioned consensus mechanisms. When all transactions are successfully confirmed, a consensus exists between all the nodes. The new blocks are linked to previous blocks and all the blocks are aligned in one continuous chain. This chain of blocks is the public ledger technique called Blockchain whereby the public ledger cannot be modified or deleted after the data has been approved by all nodes.

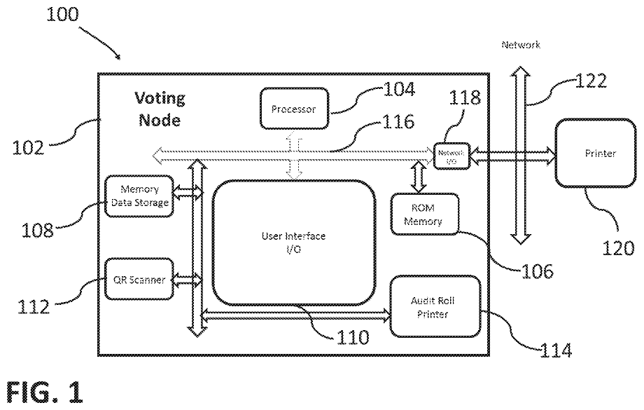

FIG. 1 illustrates an exemplary Voting Node 100 according to an aspect of the present disclosure. Voting Node comprises a voting apparatus 102 configured with a non-limiting number of components including a processor 104, a ROM memory device 106, memory data storage device 108, a user interface I/O device 110, a QR scanner 112, and Audit Roll Printer 114. Audit Roll Printer 114 is accessible externally-internally for retrieving one or more Audit Roll outputs. The components are interconnected and communicating with processor 104 via one or more depicted bus line 116. Bus line 116 in conjunction with a network interface I/O 118 enable apparatus 102 and its components to be connected to an external printer 120 and external network 122. In a preferred embodiment, a voter can access a Vote Key generator of apparatus 102, to generate a Vote Key, comprising a cryptographically secure keypair, that is transmittable to external printer 120. External printer 120 is a matter of design choice for embodiments in which voting node 100 is configured to generate a paper-based output. In certain embodiments, voting node 100 may be configured to transmit the Vote Key to other forms of physical media, such as external memory devices, USB drives, magnetic or chip-enables cards, and the like. Likewise, audit roll 114 may comprise other types of storage/output media formats in place of paper-based printing, such as those listed above. External network 122 enables Voting Node 100 to connected with one or more external Voting Nodes. In various embodiments, user interface I/O device 110 may include one or more non-limiting touch screen, keypad, keyboard, mouse, microphone, speaker, or the like, to enable a voter to interact, input information, receive output information, with or from voting apparatus 102. Apparatus 102 and its internal components may be combined with additional hardware, communicating hardware, firmware, and software to enable to the device to execute instructions, codes, protocols, communicate by wire or wireless with other computing device, Bluetooth technology, WIFI, cellular network, including connecting to an Intranet, LAN, WAN, Internet, or the like. In an embodiment, one or more Voting Node 100 executes a complete instance of the voting Blockchain Protocol. In a preferred embodiment, one or more Voting Node 100 is connected to another Voting Node utilizing a secured, permissioned networking protocol. In yet another preferred embodiment, all the Voting Nodes are connected to all other Voting Nodes utilizing said secure external network 122, one or more additional networks, all networks operating with a non-limiting permissioned network protocol.

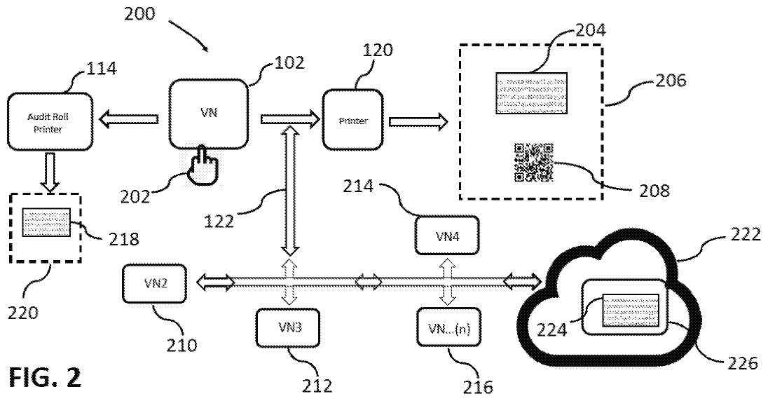

FIG. 2 illustrates an exemplary Voting Method 200 according to an aspect of the present disclosure. The voting method begins with a figurative voter 202 using the Vote Key generator of Voting Note (“VN”) 102, described in FIG. 1, to create a cryptographic keypair 204 (i.e.,“Vote Key”), at a polling location, preferably under the supervision of, but not limited to, poll workers. In an embodiment, keypair 204 comprise a public key, a private key, or combinations thereof. Keypair 204 is printed by printer 120 of FIG.1 onto a paper receipt 206 that includes a barcode 208, preferably a non-limiting Quick Response (OR) code 208. In a preferred embodiment, OR code 208 is a private key and can only be used one time in a Blockchain Protocol and restricted to the signing of a single casted vote (“Vote Signature”). In another preferred embodiment, voter 202 enters one or more votes for one or more election candidates and Voting Node 102 subsequently queries said voter to sign for the votes using the Voting Key, designated as keypair 204.

In yet another preferred embodiment, upon signing and or vote casting, the vote is distributed, via said communication network 122 of FIG. 1, to one or more VN2 210, VN3 212, VN4 214, or VN . . . (n) 216 and secured cryptographically through the Blockchain Protocol. It is understood that the number of VNs listed here is only for illustrative purposes and that the said is distributed to a non-limiting peer-to-peer distributed network, including network 122, with a potentially unlimited number of nodes. In yet another preferred embodiment, upon Vote Signature and/or vote casting, a voter's public key 218 is recorded on Audit Roll 220 by Audit Roll printer 114 located within apparatus 102 of FIG. 1. The record along with numbers corresponds to each vote casted by the voter according to a pre-published scheme or to specified addresses associated with candidates in the election. In yet another preferred embodiment, one or more said VN(s) is connected to, a cloud network, preferably but not limited to, Internet 222. Under this method, voter 202 can access blockchain record 224, created using the said Blockchain Protocol, using a blockchain explorer 226 openly provided on the Internet 222. In yet another embodiment, a voter can challenge an incorrectly recorded vote using the said receipt 206 and confirmed by an authorized reviewer. In another preferred embodiment, the recorded vote and receipt can be reconciled with the information generated contemporaneously by the Audit Roll 120 generated by Audit Roll printer 114 of the voting apparatus 102 described in FIG. 1.

The present disclosure includes that contained in the appended claims as well as that of the foregoing description. Although this invention has been described in its exemplary forms with a certain degree of particularity, it is understood that the present disclosure of has been made only by way of example and numerous changes in the details of construction and combination and arrangement of parts may be employed without departing from the spirit and scope of the invention.

What is claimed is:

1. A cryptographically secure voting system comprising:
at least one voting node comprising a computerized terminal having at least one computer processor, microprocessor, controller, memory storage device, data storage device, user input-output interface device, a first printer, quick response code scanner, and a network connection I/O interface device, the at least one voting node executing an instance of a voting blockchain protocol, the at least one voting node being operably engaged with a communications network to execute a permissioned networking protocol; and,
a vote key generator operably engaged with the at least one voting node to access a blockchain record, the vote key generator comprising a cryptographically secure offline keypair and a second printer, the vote key generator being operable to generate a vote signature output comprising a printed barcode embedded with a public-private cryptographic keypair.

2. A method for cryptographically secure electronic voting, comprising:
creating, with a vote key generator operably engaged with at least one voting node to access a blockchain record, a cryptographic keypair;
printing, with a printer communicably engaged with the vote key generator, a paper receipt comprising the cryptographic keypair;
entering a voter input into a voting node, the voter input comprising a vote selection;
entering a voter signature into the voting node, the voter signature comprising the cryptographic keypair;
distributing the voter input to one or more voter nodes via a blockchain protocol to create a blockchain record associated with the voter input;
recording, with an audit roll printer, the voter input on an audit roll; and,
accessing, via a Web browser, a blockchain explorer to compare the audit roll with ti blockchain record to verify accuracy of the voter input.

3. A method for cryptographically secure electronic voting, comprising:
creating, with a voting node executing a blockchain protocol, a voter signature comprising a cryptographic keypair;
printing, with a printer, a machine-readable code corresponding to the voter signature;
inputting a voter input and the voter signature into the voting node;
creating, with the voting note, a blockchain record corresponding to the voter input and the voter signature;
creating, with an audit log, an audit record corresponding to the voter input and the voter signature;
printing, with an audit printer, the audit record; and, comparing, via a blockchain explorer application, the blockchain record and the audit record.
